(19) United States
(12) Patent Application Publication
(10) Pub. No.: US 2024/0187932 A1
(43) Pub. Date: Jun. 6, 2024

(54) NETWORK NODES AND METHODS THEREIN FOR QUALITY OF SERVICE CONTROL

(71) Applicant: Telefonaktiebolaget LM Ericsson (publ), Stockholm (SE)

(72) Inventor: Huaisong ZHU, Beijing (CN)

(21) Appl. No.: 18/285,930

(22) PCT Filed: Apr. 9, 2021
(86) PCT No.: PCT/CN2021/086231

§ 371 Date: Oct. 6, 2023

(51) Int. Cl. H04W 28/08

(52) U.S. Cl. CPC H04W 28/0967; H04W 28/0831

(57) ABSTRACT

The present disclosure provides a method in an application server for Quality of Service, QoS, control. The method includes: determining to adjust a QoS associated with a service for one or more terminal devices; and transmitting, to a control function entity, a request for adjusting the QoS for the one or more terminal devices.

### TECHNICAL FIELD

The present disclosure relates to communication technology, and more particularly, to network nodes and methods therein for Quality of Service (QoS) control.

### BACKGROUND

The 5th Generation (5G) communication technology is targeting to be applicable to different scenarios, including both a To Customer (ToC) scenario and a To Business (ToB) scenario. One of the most significant differences between the ToB scenario and the ToC scenario is the former has differentiated service requirements. For example, even within a smart factory, device status monitoring may require a wide coverage, while photo/video uploading may require a high bandwidth and a low latency.

To make the 5G communication technology adaptive to these diverse requirements flexibly, capabilities of a 5G Radio Access Network (RAN) device are desired to be known to not only different air environments, but also to different applications, so as to guarantee Service Level Assurance (SLA) for different 5G applications.

To achieve such cognition, a control function entity, which may be referred to as a Radio Intelligent Management and Control (RIMC), can be introduced into the 5G communication network for the ToB scenario.

FIG. 1 is a schematic diagram illustrating a 5G communication architecture for a ToB scenario (a smart factory 110 in this example), in which a control function entity 112 (e.g., an RIMC) is included. As an example, a User Plane Function (UPF) 115 may be located within the factory 110, so as to guarantee that the data flow path is physically restricted within the factory 110. The UPF 115 may communicate with an application server 111 via an N6 interface, with a RAN device 113 via an N3 interface, and with a 5G Core (5GC) 121 located in an operator network 120 via an N4 interface. The 5GC 121 may communicate with the RAN device 113 via an N2 interface.

The control function entity 112 may communicate with the RAN device 113 (e.g., a (next) generation NodeB, or gNB) via a private interface, and the RAN device 113 may communicate with a terminal device 114 (also referred to as User Equipment (UE)) via a Uu interface. As shown in FIG. 1, the application server 111 may communicate with the control function entity 112 directly and interact with the RAN device 113 via the control function entity 112, thereby achieving RAN capability exposure. In particular, on one hand, the application server 111 can monitor a condition or status of the RAN device 113 and/or the RAN device 113 can report a measurement or capability, e.g., path loss or air resource status, to the application server 111 via the control function entity 112, such that the application server 111 can estimate future RAN performance or capability and accordingly adjust its requirement in advance (e.g., reduce the resolution of a photo to be uploaded/downloaded). On the other hand, the application server 111 may configure or provision the RAN device 113 according to its service requirement, such as a required QoS. For example, if the application server 111 plans to transfer heavy uplink/downlink traffic, it may configure the RAN device 113 with one or more parameters, e.g., an uplink/downlink slot, via the control function entity 112.

FIG. 2 is a schematic diagram illustrating a 5G QoS framework for data transfer. In the 5G communication technology, each uplink or downlink Internet Protocol (IP) packet transferred by a 5G network is mapped to a QoS flow. The mapping is preconfigured by a network operator in accordance with its policy, and is typically based on:
a source IP address;
a destination IP address;
a source port number;
a destination port number; and/or
a protocol identifier (ID) (e.g., Transmission Control Protocol (TCP), User Datagram Protocol (UDP), or Internet Control Message Protocol (ICMP)).

This QoS flow mechanism provides end-to-end forwarding between a UE and a UPF throughout the lifetime of a Protocol Data Unit (PDU) session. As shown in FIG. 2, for a PDU session, a radio bearer is established between the UE and a NodeB (NB) in a Next Generation RAN (NG-RAN), and a Next Generation-User Plane (NG-U) tunnel is established between the NB and a UPF in a 5G Core (5GC). End-to-end QoS flows are provided between the UE and the UPF. Each of the QoS flows is characterized by a set of parameters defined in a QoS profile, for example, 5G QoS Identifier (5QI), Allocation and Retention Priority (ARP), or Guaranteed Flow Bit Rate (GFBR). In this way, the 5G QoS framework may provide different priority levels for different applications based on QoS flows.

FIGS. 3A and 3B are schematic diagrams illustrating an exemplary process of QoS control. As shown in FIG. 3A, at 3.0, an operator may preconfigure a set of possible QoS profiles or QoS parameters for a RAN device 113 and a 5GC 121 via an Operation Administration and Maintenance (OAM) system 122. As shown in FIG. 3B, at 3.1, an application server 111 transmits, to the 5GC 121, a request for adjusting a QoS associated with a service. Then at 3.2, the 5GC 121 reconfigures the RAN device 113 according to the received request, e.g., to inform the RAN device 113 changes in QoS parameters (e.g., a different 5QI).

### SUMMARY

The QoS requirement for each QoS flow may not be constant or fixed, but may be dynamic and may change fast, e.g., on the order of tens of milliseconds. As an example, in a case of photo/video uploading for drone based asset inspection controlled by a robot, a photo resolution (or a corresponding volume of data to be uploaded) may change fast for different photo post-processing purposes, and a required QoS (e.g., a throughput) associated with the photo/video uploading may change accordingly, which imposes a high requirement on adjustment of the QoS associated with the service, e.g., on the order of tens of milliseconds. In the QoS control process shown in FIGS. 3A and 3B, however, the 5GC 121 located in the operator network 120 is involved, which results in a high delay due to the geometry separation between the 5GC 121 and the network nodes or devices located within the factory 110.

Furthermore, in the current QoS framework shown in FIG. 2, a QoS associated with a service can only be (pre)configured/adjusted based on a QoS flow or service, which lacks flexibility in QoS control. As an example, FIGS. 4A and 4B are schematic diagrams illustrating QoSs associated with a service for different terminal devices. As shown in FIG. 4A, UE1, UE2, and UE3 have the same QoS requirement/target associated with a service, for example, a photo/video uploading service. A RAN device (e.g., the RAN device 113 shown in FIG. 1) tries to guarantee all the UEs' QoS requirements. Due to, for example, differences in their path losses, some UEs (e.g., UE1 and UE3) may get higher throughputs than others (e.g., UE2), but all the UEs' QoS targets are fulfilled. After a short while, as shown in FIG. 4B, UE1 and UE3 may have their QoS requirements/targets unchanged, while UE2 needs to increase its QoS requirement/target for a period of time so as to upload a higher resolution photo. However, with the QoS control at a granularity of QoS flow or service, all the UEs can only have the same QoS requirement/target, which may cause an unnecessary waste of resources for some of the UEs and/or unfulfilled QoS requirements/targets for others.

It is an object of the present disclosure to provide network nodes and methods therein for QoS control, capable of solving at least one of the above problems.

According to a first aspect of the present disclosure, a method in an application server for QoS control is provided. The method includes: determining to adjust a QoS associated with a service for one or more terminal devices; and transmitting, to a control function entity, a request for adjusting the QoS for the one or more terminal devices.

In an example, the operation of determining to adjust the QoS may include determining to adjust the QoS for a time period, and the request may be for adjusting the QoS for the time period.

In an example, the operation of determining to adjust the QoS may be based on an estimated QoS for the service and a required QoS for the service.

In an example, the estimated QoS may be determined based on a QoS measured previously for the service by the application server.

In an example, the request may contain the required QoS, or a QoS profile or QoS parameter based on the required QoS.

In an example, the QoS may be based on a default QoS profile or QoS parameter and the operation of determining to adjust the QoS may be based on a required QoS for the service being higher than the QoS.

In an example, the method may further include: determining to adjust back to the QoS based on the default QoS profile or QoS parameter; and transmitting, to the control function entity, a request for adjusting back to the QoS based on the default QoS profile or QoS parameter.

In an example, the operation of determining to adjust the QoS may be further based on a measurement or capability related to a RAN device from the control function entity.

In an example, the one or more terminal devices may be associated with one or more terminal device identifiers (IDs), a source Internet Protocol (IP) address, a destination IP address, a source port number, and/or a destination port number.

In an example, the control function entity may interface with the RAN device.

In an example, the control function entity may be an RIMC function entity.

In an example, the application server, the RAN device, and the control function entity may be deployed in a ToB scenario.

According to a second aspect of the present disclosure, an application server is provided. The application server includes a communication interface, a processor and a memory. The memory stores instructions executable by the processor whereby the application server is operative to perform the method according to the above first aspect.

According to a third aspect of the present disclosure, a computer readable storage medium is provided. The computer readable storage medium has computer program instructions stored thereon. The computer program instructions, when executed by a processor in an application server, cause the application server to perform the method according to the above first aspect.

According to a fourth aspect of the present disclosure, a method in a control function entity for QoS control is provided. The method includes: receiving, from an application server, a request for adjusting a QoS associated with a service for one or more terminal devices; and transmitting, to a RAN device, a QoS profile or QoS parameter associated with the service for the one or more terminal devices based on the request, or a scheduling configuration associated with the service for the one or more terminal devices based on the request.

In an example, the request may be for adjusting the QoS for a time period, and the QoS profile or QoS parameter or the scheduling configuration may be associated with the time period.

In an example, the request may contain a required QoS for the service, and the method may further include: determining the QoS profile or QoS parameter or the scheduling configuration based on the required QoS.

In an example, the QoS may be based on a default QoS profile or QoS parameter and the request may be received in response to the required Qos for the service being higher than the QoS.

In an example, the QoS profile or QoS parameter or the scheduling configuration may be determined further based on a measurement or capability related to the RAN device.

In an example, the method may further include: transmitting, to the application server, the measurement or capability related to the RAN device.

In an example, the method may further include: receiving, from the application server, a request for adjusting back to the QoS based on the default QoS profile or QoS parameter; and transmitting, to the RAN device, the default QoS profile or QoS parameter.

In an example, the request may contain the QoS profile or QoS parameter.

In an example, the request may contain a requested QoS profile or QoS parameter for the service, and the method may further include: determining the QoS profile or QoS parameter or the scheduling configuration based on the requested QoS profile or QoS parameter.

In an example, the QoS profile or QoS parameter or the scheduling configuration may be determined further based on a measurement or capability related to the RAN device.

In an example, the one or more terminal devices may be associated with one or more terminal device IDs, a source IP address, a destination IP address, a source port number, or a destination port number.

In an example, the control function entity may be an RIMC function entity.

In an example, the application server, the RAN device, and the control function entity may be deployed in a ToB scenario.

According to a fifth aspect of the present disclosure, a control function entity is provided. The control function entity includes a communication interface, a processor and a memory. The memory stores instructions executable by the processor whereby the control function entity is operative to perform the method according to the above fourth aspect.

According to a sixth aspect of the present disclosure, a computer readable storage medium is provided. The computer readable storage medium has computer program instructions stored thereon. The computer program instructions, when executed by a processor in a control function entity, cause the control function entity to perform the method according to the above fourth aspect.

According to a seventh aspect of the present disclosure, a method in a RAN device for QoS control is provided. The method include: receiving, from a control function entity, a QoS profile or QoS parameter for a service for adjusting a QoS associated with the service for one or more terminal devices, or a scheduling configuration for a service for adjusting a QoS associated with the service for one or more terminal devices; and applying the QoS profile or QoS parameter or the scheduling configuration to the service for the one or more terminal devices.

In an example, the QoS profile or QoS parameter or the scheduling configuration may be associated with a time period, and the operation of applying the QoS profile or QoS parameter or the scheduling configuration may include applying the QoS profile or QoS parameter or the scheduling configuration for the time period.

In an example, the QoS profile or QoS parameter may be a default QoS profile or QoS parameter, or may be dependent on a measurement or capability related to the RAN device.

In an example, the one or more terminal devices may be associated with one or more terminal device IDs, a source IP address, a destination IP address, a source port number, or a destination port number.

In an example, the control function entity may be an RIMC function entity.

In an example, the RAN device and the control function entity may be deployed in a ToB scenario.

According to an eighth aspect of the present disclosure, a RAN device is provided. The RAN device includes a communication interface, a processor and a memory. The memory stores instructions executable by the processor whereby the RAN device is operative to perform the method according to the above seventh aspect.

According to a ninth aspect of the present disclosure, a computer readable storage medium is provided. The computer readable storage medium has computer program instructions stored thereon. The computer program instructions, when executed by a processor in a RAN device, cause the RAN device to perform the method according to the above seventh aspect.

With the embodiments of the present disclosure, QoS control can be provided at a finer granularity of a terminal device. Furthermore, the whole QoS control process can be performed locally by an application server, a RAN device, and a control function entity that are deployed in a ToB scenario, without involving an external 5GC. In this way, the QoS control can be improved in terms of latency and efficiency.

### BRIEF DESCRIPTION OF THE DRAWINGS

The above and other objects, features and advantages will be more apparent from the following description of embodiments with reference to the figures, in which:

FIG. 1 is a schematic diagram illustrating a 5G communication architecture for a ToB scenario;

FIG. 2 is a schematic diagram illustrates a 5G QoS framework for data transfer;

FIGS. 3A and 3B are schematic diagrams illustrating an exemplary process of QoS control;

FIGS. 4A and 4B are schematic diagrams illustrating QoSs associated with a service for different terminal devices;

FIG. 5 is a flowchart illustrating a method in an application server for QoS control according to an embodiment of the present disclosure;

FIG. 6 is a flowchart illustrating a method in a control function entity for QoS control according to an embodiment of the present disclosure;

FIG. 7 is a flowchart illustrating a method in a RAN device for QoS control according to an embodiment of the present disclosure;

FIG. 8 is a schematic diagram illustrating an exemplary process of QoS control according to an embodiment of the present disclosure;

FIG. 9 is a block diagram of an application server according to an embodiment of the present disclosure;

FIG. 10 is a block diagram of an application server according to another embodiment of the present disclosure;

FIG. 11 is a block diagram of a control function entity according to an embodiment of the present disclosure;

FIG. 12 is a block diagram of a control function entity according to another embodiment of the present disclosure;

FIG. 13 is a block diagram of a RAN device according to an embodiment of the present disclosure;

FIG. 14 is a block diagram of a RAN device according to another embodiment of the present disclosure;

FIG. 15 schematically illustrates a telecommunication network connected via an intermediate network to a host computer;

FIG. 16 is a generalized block diagram of a host computer communicating via a base station with a user equipment over a partially wireless connection; and

FIGS. 17 to 20 are flowcharts illustrating methods implemented in a communication system including a host computer, a base station and a user equipment.

### DETAILED DESCRIPTION

In the following, references in the specification to “one embodiment”, “an embodiment”, “an example embodiment” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

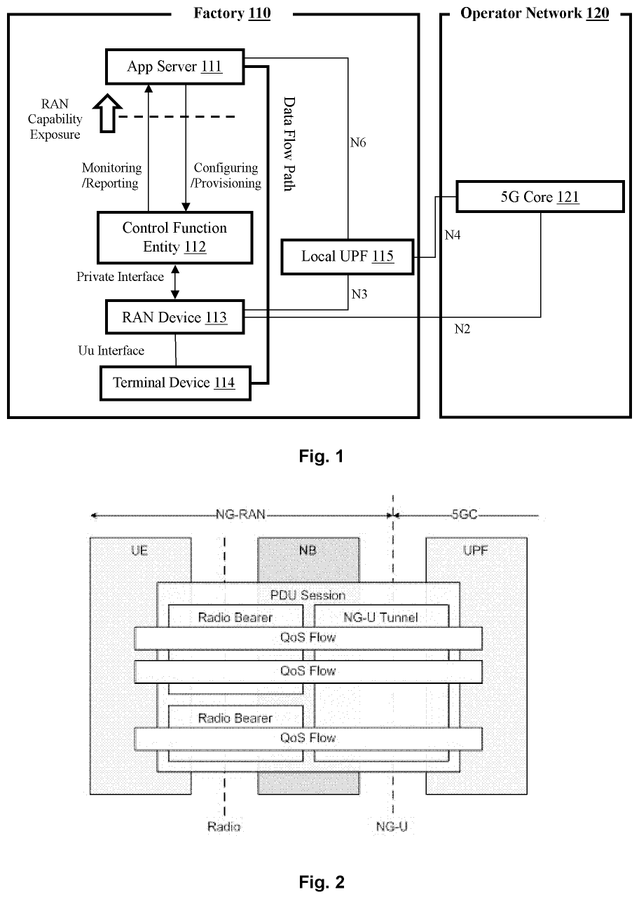

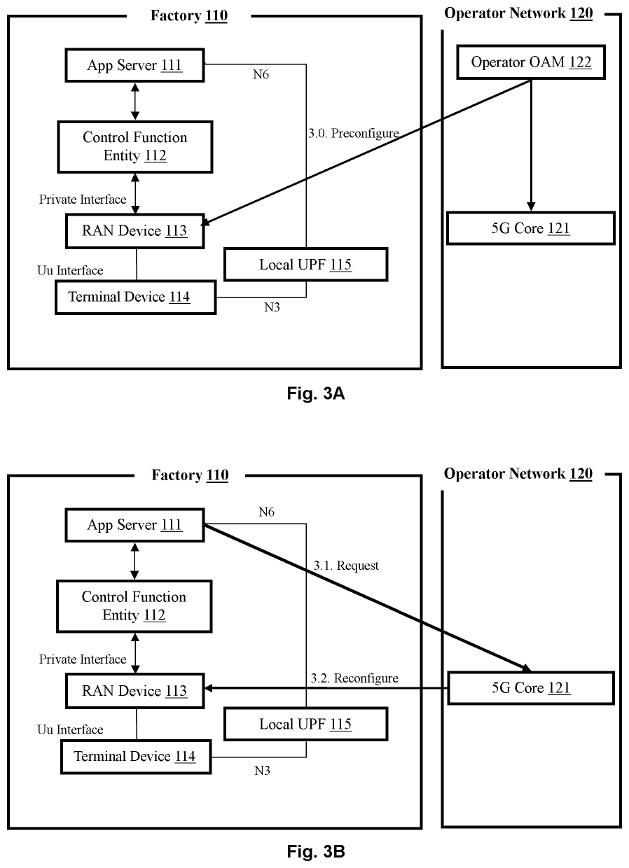

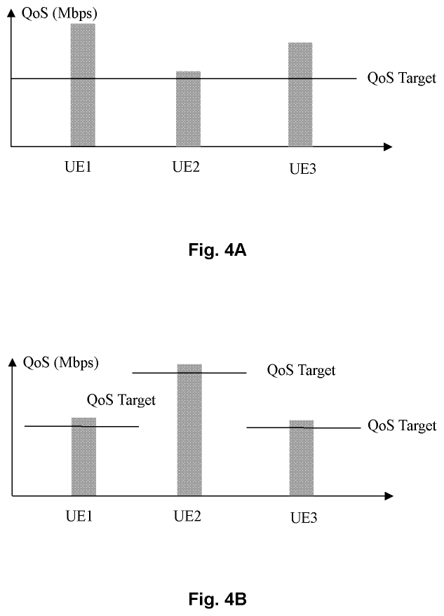

Conventionally in a ToC scenario for example, the 5G network should not be aware of the content of IP packets for security reasons, as users do not want to expose their data to the 5G network operator. However, in a ToB scenario, especially a private 5G network configuration like the smart factory 110 in FIG. 1, the application server 111, the control function entity 112, the RAN device 113, the terminal device 114, and the UPF 115 all belong to the same factory 110, and thus the security issue is not as important as in the ToC scenario and QoS control can be content aware.

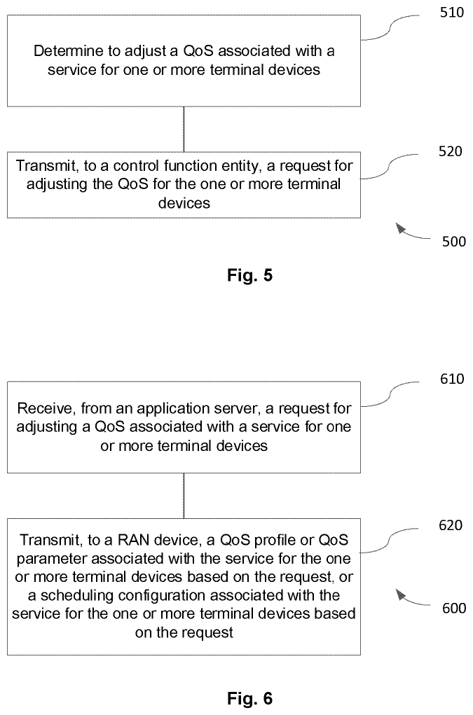

FIG. 5 is a flowchart illustrating a method 500 for QoS control according to an embodiment of the present disclosure. The method may be performed, e.g., by an application server (e.g., the application server 111 in FIG. 1).

At block 510, the application server determines to adjust a QoS associated with a service for one or more terminal devices. In an example, the one or more terminal devices may be associated with one or more terminal device IDs, a source IP address, a destination IP address, a source port number, and/or a destination port number. In this way, the QoS control can be provided at a granularity of a terminal device which is finer than a granularity of a QoS flow.

At block 520, the application server transmits, to a control function entity (e.g., the control function entity 112 in FIG. 1, which may be an RIMC), a request for adjusting the QoS for the one or more terminal devices.

In an example, in the block 510, it may be determined to adjust the QoS for a time period. Accordingly, the request in the block 520 may be for adjusting the QoS for the time period.

In an example, in the block 510, it may be determined to adjust the QoS based on an estimated QoS for the service and a required QoS for the service. Here, for example, the estimated QoS may be determined based on a QoS measured previously for the service by the application server. In this case, the request in the block 520 may contain the required QoS, or a QoS profile or QoS parameter based on the required QoS. For example, when it is determined that an estimated latency (e.g., obtained based on a throughput previously measured by the application server) is greater than a required latency, it may be determined in the block 510 to adjust the QoS, and the request in the block 520 may contain the required latency, a Guaranteed Flow Bit Rate (GFBR) calculated based on the required latency, or a QoS profile including the GFBR.

In another example, the QoS associated with the service may be based on a default QoS profile or QoS parameter and, in the block 510, it may be determined to adjust the QoS based on a required QoS for the service being higher than the QoS based on the default QoS profile or QoS parameter. Further, e.g., after the time period or when the required QoS drops later to a level equal to or lower than the QoS based on the default QoS profile or QoS parameter, the application server can determine to adjust back to the QoS based on the default QoS profile or QoS parameter; and transmit, to the control function entity, a request for adjusting back to the QoS based on the default QoS profile or QoS parameter.

In an example, the control function entity may interface with a RAN device (e.g., the RAN device 113 in FIG. 1, which may be a gNB), and the application server, the control function entity, and the RAN device may be deployed in a ToB scenario, as shown in FIG. 1. In the block 510, it may be determined to adjust the QoS further based on a measurement or capability related to the RAN device received from the control function entity. For example, the estimated QoS can be obtained based not only on the QoS measured previously for the service by the application server, but also on the measurement or capability related to the RAN device. For instance, the application server may determine from the measurement or capability related to the RAN device that the RAN device can now provide a higher or lower QoS than the previously measured QoS, and determine whether to adjust the QoS or not accordingly in the block 510.

FIG. 6 is a flowchart illustrating a method 600 for QoS control according to an embodiment of the present disclosure. The method may be performed, e.g., by a control function entity (e.g., the control function entity 130 in FIG. 1). In an example, the control function entity may be an RIMC.

At block 610, a control function entity receives, from an application server, a request for adjusting a QoS associated with a service for one or more terminal devices. In an example, the one or more terminal devices may be associated with one or more terminal device IDs, a source IP address, a destination IP address, a source port number, or a destination port number. In this way, the QoS control can be provided at a granularity of a terminal device which is finer than a granularity of a QoS flow.

At block 620, the control function entity transmits, to a RAN device (e.g., the RAN device 113 in FIG. 1, which may be a gNB), a QoS profile or QoS parameter (e.g., a GFBR or a maximum packet loss rate) associated with the service for the one or more terminal devices based on the request, or a scheduling configuration (e.g., a bandwidth or a radio resource) associated with the service for the one or more terminal devices based on the request. In an example, the application server, the RAN device, and the control function entity may be deployed in a ToB scenario, as shown in FIG. 1.

In an example, the request transmitted in the block 610 may be for adjusting the QoS for a time period. Accordingly, the QoS profile or QoS parameter or the scheduling configuration transmitted to the RAN device in the block 620 may be associated with the time period, e.g., to be applied for the time period.

In an example, the request in the block 610 may contain a required QoS for the service. Accordingly, in the block 620, the control function entity may determine the QoS profile or QoS parameter or the scheduling configuration based on the required QoS. For example, the control function entity may calculate a GFBR or determine a radio resource allocation based on a required latency.

For example, the QoS associated with the service may be based on a default QoS profile or QoS parameter and in the block 610, the request may be received in response to the required QoS for the service being higher than the QoS. Further, e.g., after the time period or when the required QoS drops later to a level equal to or lower than the QoS based on the default QoS profile or QoS parameter, the control function entity may receive, from the application server, a request for adjusting back to the QoS based on the default QoS profile or QoS parameter, and transmit, to the RAN device, the default QoS profile or QoS parameter.

For example, the QoS profile or QoS parameter or the scheduling configuration may be determined further based on a measurement or capability related to the RAN device. Here, the control function entity can receive the measurement or capability related to the RAN device from the RAN device, and then transmit it to the application server. For example, the control function entity can determine the QoS profile or QoS parameter or the scheduling configuration based on the required QoS to match the measurement or capability related to the RAN device.

In another example, the request transmitted in the block 610 may contain the QoS profile or QoS parameter. In this case, the control function entity can simply forward the QoS profile or QoS parameter to the RAN device transparently.

In yet another example, the request transmitted in the block 610 may contain a requested QoS profile or QoS parameter for the service. In this case, the control function entity may determine the QoS profile or QoS parameter or the scheduling configuration based on the requested QoS profile or QoS parameter. For example, the QoS profile or QoS parameter or the scheduling configuration may be determined further based on a measurement or capability related to the RAN device. For example, the control entity can determine the QoS profile or QoS parameter or the scheduling configuration based on the requested QoS profile or QoS parameter to match the measurement or capability related to the RAN device.

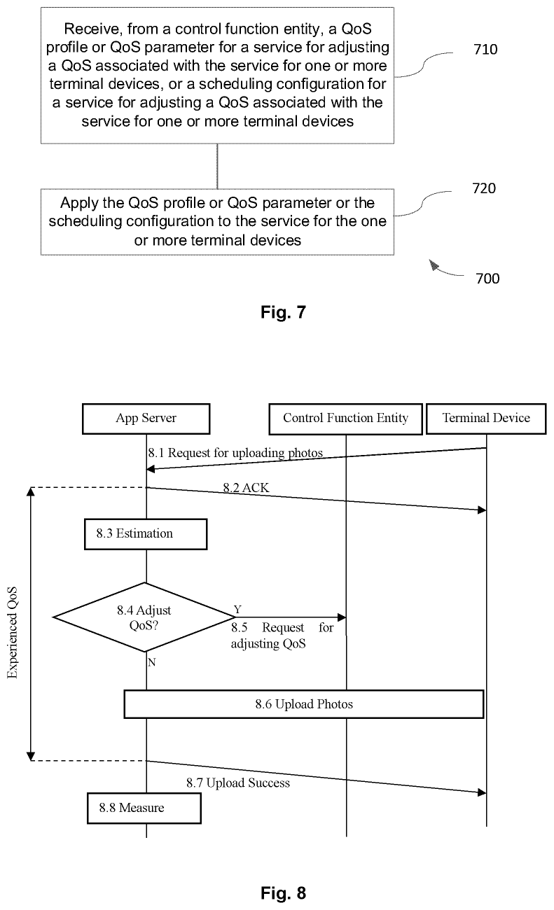

FIG. 7 is a flowchart illustrating a method 700 for QoS control according to an embodiment of the present disclosure. The method may be performed, e.g., by a RAN device (e.g., the RAN device 113 in FIG. 1).

At block 710, a RAN device receives, from a control function entity (e.g., the control function entity 112 in FIG. 1, which may be an RIMC), a QoS profile or QoS parameter (e.g., a GFBR or a maximum packet loss rate) for a service for adjusting a QoS associated with the service for one or more terminal devices, or a scheduling configuration (e.g., a bandwidth or a radio resource) for a service for adjusting a QoS associated with the service for one or more terminal devices. For example, the one or more terminal devices may be associated with one or more terminal device IDs, a source IP address, a destination IP address, a source port number, or a destination port number.

In this way, the QoS control can be provided at a granularity of a terminal device which is finer than a granularity of a QoS flow.

At block 720, the RAN device applies the QoS profile or QoS parameter or the scheduling configuration to the service for the one or more terminal devices.

In an example, the QoS profile or QoS parameter or the scheduling configuration received in the block 710 may be associated with a time period. Accordingly, in the block 720, the RAN device may apply the QoS profile or QoS parameter or the scheduling configuration for the time period.

In an example, the QoS profile or QoS parameter received in the block 710 may be a default QoS profile or QoS parameter. For example, the default QoS profile or QoS parameter may be transmitted by the control function entity upon receiving from an application server, a request for adjusting back to the QoS based on the default QoS profile or QoS parameter. In another example, the QoS profile or QoS parameter received in the block 710 may be dependent on a measurement or capability related to the RAN device. For example, as described above in connection with the methods 500 and 600, the QoS profile or QoS parameter may be determined by an application server or the control function entity based at least on the measurement or capability related to the RAN device. In an example, the application server, the RAN device, and the control function entity may be deployed in a ToB scenario.

FIG. 8 is a schematic diagram illustrating an exemplary process of QoS control according to an embodiment of the present disclosure. In this example, a photo uploading service is assumed.

At 8.1, a terminal device or more specifically an application within the terminal device may transmit, to an application server, a request for uploading photos. At 8.2, the application server may respond to the terminal device with an acknowledgement (ACK) message. The ACK message may contain one or more photo requirements of the application server, e.g., resolution, number of photos to be uploaded, etc.

At 8.3, the application server may estimate a QoS, e.g., latency and/or throughput, associated with the photo uploading service. Here, the estimation may be based on the one or more photo requirements and an experienced QoS measured previously by the application server for photo uploading. For example, the experienced throughput measured previously for photo uploading may be 60 Mbps, and the data size of the photo to be uploaded this time (e.g., according to the one or more photo requirements) is 3 MB=24 Mbits, thus the estimated latency=24 Mbits/60 Mbps=0.4 second. After obtaining the estimated QoS, the application server may determine whether the current QoS provided by a RAN device needs to be adjusted or not at 8.4. Continuing with the above example, if a required latency for the photo uploading service is 0.3 second (<0.4 second), it means that the current throughput provided by the RAN device cannot fulfill the required latency. Thus the application server may determine to adjust the QoS associated with the photo uploading service. In this case, the application server may transmit, to the control function entity, a request for adjusting the QoS at 8.5. In an example, the request may contain a QoS profile or QoS parameter, e.g., a GFBR set to 24 Mbits/(0.3 second-0.05 second)=96 Mbps, where a latency margin of 0.05 second is taken into account.

The request transmitted at 8.5 may contain a requested QoS profile or Qos parameter for the photo uploading service, based on which a QoS profile or QoS parameter associated with the photo uploading service or a scheduling configuration associated with the photo uploading service can be determined. Table 1 shows some exemplary QoS parameters defined by Information Elements (IEs).

TABLE 1
Exemplary QoS parameters

| IE/Group Name | Presence | Semantics description |
|---|---|---|
| C-RNTI | M | UE ID |
| Source port number | O | Port number of the application at |
| | | UE side |
| Destination port | O | Port number of the application at |
| number | | network side |
| Guaranteed Flow Bit | M | Guaranteed Bit Rate (provided there |
| Rate Downlink | | is data to deliver) in DL. |
| Guaranteed Flow Bit | M | Guaranteed Bit Rate (provided there |
| Rate Uplink | | is data to deliver) in UL |
| Maximum Packet Loss | O | Indicates the maximum rate for lost |
| Rate Downlink | | packets that can be tolerated in the |
| | | downlink direction. |
| Maximum Packet Loss | O | Indicates the maximum rate for lost |
| Rate Uplink | | packets that can be tolerated in the |
| | | uplink direction. |

At 8.6, the terminal device uploads the photo to the application server based on the one or more photo requirements of the application server. At 8.7, the application server transmits, to the terminal device, a message indicating that the photo uploading has succeeded. At 8.8, the application server measures an experienced QoS, e.g., latency and/or throughput, associated with the photo updating at 8.6, for use in QoS estimation for a subsequent photo uploading service. For example, the experienced QoS (latency) may be measured as a latency between transmitting an ACK message at 8.2 to transmitting the message indicating that the photo uploading has succeeded at 8.7.

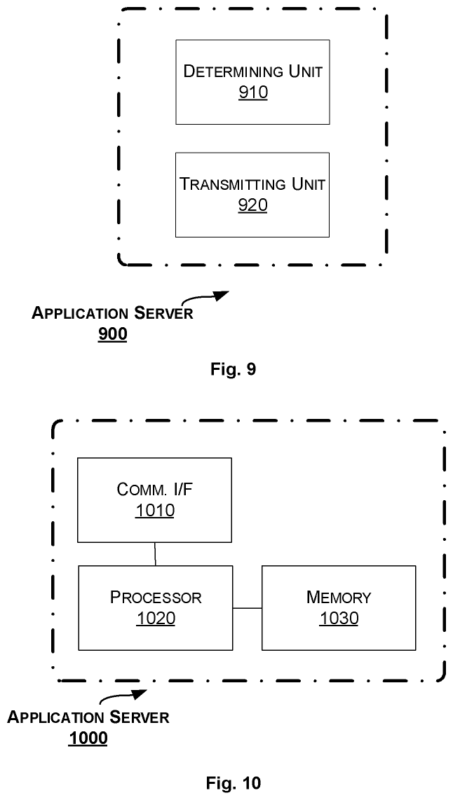

Correspondingly to the method 500 as described above, an application server is provided. FIG. 9 is a block diagram of an application server 900 according to an embodiment of the present disclosure.

The application server 900 can be the application server 111 shown in FIG. 1, and can be configured to perform the method 500 as described above in connection with FIG. 5. As shown in FIG. 9, the application server 900 includes a determining unit 910 configured to determine to adjust a QoS associated with a service for one or more terminal devices. The application server 900 further includes a transmitting unit 920 configured to transmit, to a control function entity, a request for adjusting the QoS for the one or more terminal devices.

In an example, the determining unit 910 may be configured to determine to adjust the QoS for a time period, and the request may be for adjusting the QoS for the time period.

In an example, the determining unit 910 may be configured to determine to adjust the QoS based on an estimated QoS for the service and a required QoS for the service.

In an example, the estimated QoS may be determined based on a QoS measured previously for the service by the application server.

In an example, the request may contain the required QoS, or a QoS profile or QoS parameter based on the required QoS.

In an example, the QoS may be based on a default QoS profile or QoS parameter and the determining unit 910 may be configured to determine to adjust the QoS based on a required QoS for the service being higher than the QoS.

In an example, the determining unit 910 may be further configured to determine to adjust back to the QoS based on the default QoS profile or QoS parameter. The transmitting unit 920 may be further configured to transmit, to the control function entity, a request for adjusting back to the QoS based on the default QoS profile or QoS parameter.

In an example, the determining unit 910 may be configured to determine to adjust the QoS further based on a measurement or capability related to a RAN device from the control function entity.

In an example, the one or more terminal devices may be associated with one or more terminal device IDs, a source IP address, a destination IP address, a source port number, and/or a destination port number.

In an example, the control function entity may interface with the RAN device.

In an example, the control function entity may be a RIMC function entity.

In an example, the application server, the RAN device, and the control function entity may be deployed in a ToB scenario.

The units 910˜920 can be implemented as a pure hardware solution or as a combination of software and hardware, e.g., by one or more of: a processor or a micro-processor and adequate software and memory for storing the software, a Programmable Logic Device (PLD) or other electronic component(s) or processing circuitry configured to perform the actions described above, and illustrated, e.g., in FIG. 5.

FIG. 10 is a block diagram of an application server 1000 according to another embodiment of the present disclosure.

The application server 1000 includes a communication interface 1010, a processor 1020 and a memory 1030. The memory 1030 contains instructions executable by the processor 1020 whereby the application server 1000 is operative to perform the actions, e.g., of the process described earlier in conjunction with FIG. 5.

As an example, the application server 1000 can be the application server 111 shown in FIG. 1. Particularly, the memory 1030 can contain instructions executable by the processor 1020 whereby the application server 1000 is operative to: determine to adjust a QoS associated with a service for one or more terminal devices; and transmit, to a control function entity, a request for adjusting the QoS for the one or more terminal devices.

In an example, the operation of determining to adjust the QoS may include determining to adjust the QoS for a time period, and the request may be for adjusting the QoS for the time period.

In an example, the operation of determining to adjust the QoS may be based on an estimated QoS for the service and a required QoS for the service.

In an example, the estimated QoS may be determined based on a QoS measured previously for the service by the application server.

In an example, the request may contain the required QoS, or a QoS profile or QoS parameter based on the required QoS.

In an example, the QoS may be based on a default QoS profile or Qos parameter and the operation of determining to adjust the QoS may be based on a required QoS for the service being higher than the QoS.

In an example, the memory 1030 may further contain instructions executable by the processor 1020 whereby the application server 1000 is operative to: determine to adjust back to the QoS based on the default QoS profile or QoS parameter; and transmit, to the control function entity, a request for adjusting back to the QoS based on the default QoS profile or QoS parameter.

In an example, the operation of determining to adjust the QoS may be further based on a measurement or capability related to a RAN device from the control function entity.

In an example, the one or more terminal devices may be associated with one or more terminal device IDs, a source IP address, a destination IP address, a source port number, and/or a destination port number.

In an example, the control function entity may interface with the RAN device.

In an example, the control function entity may be a RIMC function entity.

In an example, the application server, the RAN device, and the control function entity may be deployed in a ToB scenario.

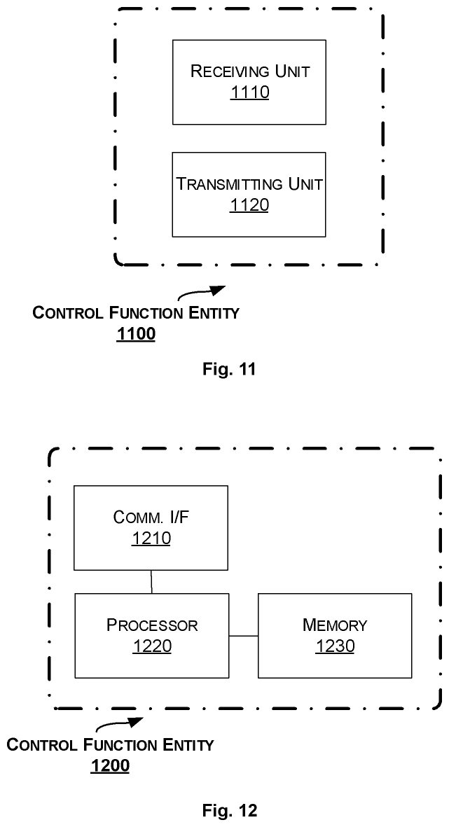

Correspondingly to the method 600 as described above, a control function entity is provided. FIG. 11 is a block diagram of a control function entity 1100 according to an embodiment of the present disclosure.

The control function entity 1100 can be the control function entity 112 shown in FIG. 1, and can be configured to perform the method 600 as described above in connection with FIG. 6. As shown in FIG. 11, the control function entity 1100 includes a receiving unit 1110 configured to: receive, from an application server, a request for adjusting a QoS associated with a service for one or more terminal devices. The control function entity 1100 further includes a transmitting unit 1120 configured to: transmit, to a RAN device, a QoS profile or QoS parameter associated with the service for the one or more terminal devices based on the request, or a scheduling configuration associated with the service for the one or more terminal devices based on the request.

In an example, the request may be for adjusting the QoS for a time period, and the QoS profile or QoS parameter or the scheduling configuration may be associated with the time period.

In an example, the request may contain a required QoS for the service. The control function entity 1100 may further include a determining unit configured to determine the QoS profile or QoS parameter or the scheduling configuration based on the required QoS.

In an example, the QoS may be based on a default QoS profile or QoS parameter and the request may be received in response to the required QoS for the service being higher than the QoS.

In an example, the QoS profile or QoS parameter or the scheduling configuration may be determined further based on a measurement or capability related to the RAN device.

In an example, the transmitting unit 1120 may be further configured to transmit, to the application server, the measurement or capability related to the RAN device.

In an example, the receiving unit 1110 may be further configured to receive, from the application server, a request for adjusting back to the QoS based on the default QoS profile or QoS parameter. The transmitting unit 1120 may be further configured to transmit, to the RAN device, the default QoS profile or QoS parameter.

In an example, the request may contain the QoS profile or QoS parameter.

In an example, the request may contain a requested QoS profile or QoS parameter for the service. The control function entity 1100 may further include a determining unit configured to determine the QoS profile or QoS parameter or the scheduling configuration based on the requested QoS profile or QoS parameter.

In an example, the QoS profile or QoS parameter or the scheduling configuration may be determined further based on a measurement or capability related to the RAN device.

In an example, the one or more terminal devices may be associated with one or more terminal device IDs, a source IP address, a destination IP address, a source port number, or a destination port number.

In an example, the control function entity may be a RIMC function entity.

In an example, the application server, the RAN device, and the control function entity may be deployed in a ToB scenario.

The units 1110˜1120 can be implemented as a pure hardware solution or as a combination of software and hardware, e.g., by one or more of: a processor or a micro-processor and adequate software and memory for storing the software, a Programmable Logic Device (PLD) or other electronic component(s) or processing circuitry configured to perform the actions described above, and illustrated, e.g., in FIG. 6.

FIG. 12 is a block diagram of a control function entity 1200 according to another embodiment of the present disclosure.

The control function entity 1200 includes a communication interface 1210, a processor 1220 and a memory 1230. The memory 1230 contains instructions executable by the processor 1220 whereby the control function entity 1200 is operative to perform the actions, e.g., of the process described earlier in conjunction with FIG. 6.

As an example, the control function entity 1200 can be the control function entity 112 shown in FIG. 1. Particularly, the memory 1230 can contain instructions executable by the processor 1220 whereby the control function entity 1200 is operative to: receive, from an application server, a request for adjusting a QoS associated with a service for one or more terminal devices; and transmit, to a RAN device, a QoS profile or QoS parameter associated with the service for the one or more terminal devices based on the request, or a scheduling configuration associated with the service for the one or more terminal devices based on the request.

In an example, the request may be for adjusting the QoS for a time period, and the QoS profile or QoS parameter or the scheduling configuration may be associated with the time period.

In an example, the request may contain a required QoS for the service, and the method may further include: determining the QoS profile or Qos parameter or the scheduling configuration based on the required QoS.

In an example, the QoS may be based on a default QoS profile or Qos parameter and the request may be received in response to the required QoS for the service being higher than the QoS.

In an example, the QoS profile or QoS parameter or the scheduling configuration may be determined further based on a measurement or capability related to the RAN device.

In an example, the memory 1230 may further contain instructions executable by the processor 1220 whereby the control function entity 1200 is operative to: transmit, to the application server, the measurement or capability related to the RAN device.

In an example, the memory 1230 may further contain instructions executable by the processor 1220 whereby the control function entity 1200 is operative to: receive, from the application server, a request for adjusting back to the QoS based on the default QoS profile or QoS parameter; and transmit, to the RAN device, the default QoS profile or QoS parameter.

In an example, the request may contain the QoS profile or QoS parameter.

In an example, the request may contain a requested QoS profile or QoS parameter for the service. The memory 1230 may further contain instructions executable by the processor 1220 whereby the control function entity 1200 is operative to: determine the QoS profile or QoS parameter or the scheduling configuration based on the requested QoS profile or QoS parameter.

In an example, the QoS profile or QoS parameter or the scheduling configuration may be determined further based on a measurement or capability related to the RAN device.

In an example, the one or more terminal devices may be associated with one or more terminal device IDs, a source IP address, a destination IP address, a source port number, or a destination port number.

In an example, the control function entity may be an RIMC function entity.

In an example, the application server, the RAN device, and the control function entity may be deployed in a ToB scenario.

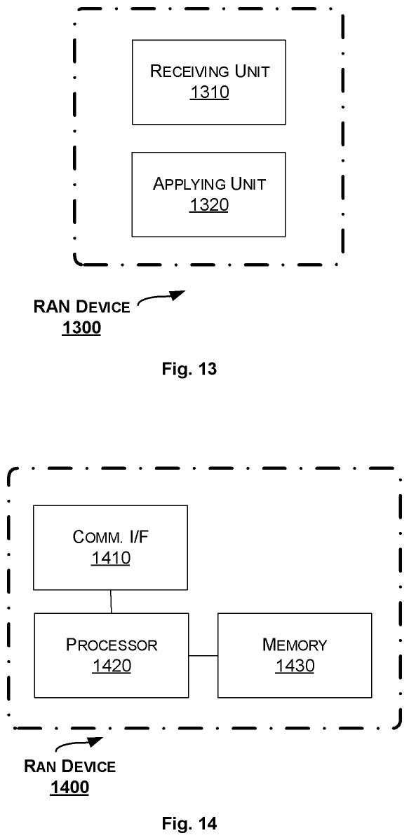

Correspondingly to the method 700 as described above, a RAN device is provided. FIG. 13 is a block diagram of a RAN device 1300 according to an embodiment of the present disclosure.

The RAN device 1300 can be the RAN device 113 shown in FIG. 1, and can be configured to perform the method 700 as described above in connection with FIG. 7. As shown in FIG. 13, the RAN device 1300 includes a receiving unit 1310 configured to: receive, from a control function entity, a QoS profile or QoS parameter for a service for adjusting a QoS associated with the service for one or more terminal devices, or a scheduling configuration for a service for adjusting a QoS associated with the service for one or more terminal devices. The RAN device 1300 further includes an applying unit 1320 configured to: apply the QoS profile or QoS parameter or the scheduling configuration to the service for the one or more terminal devices.

In an example, the QoS profile or QoS parameter or the scheduling configuration may be associated with a time period, and the applying unit 1320 may be configured to apply the QoS profile or QoS parameter or the scheduling configuration for the time period.

In an example, the QoS profile or QoS parameter may be a default QoS profile or QoS parameter, or may be dependent on a measurement or capability related to the RAN device.

In an example, the one or more terminal devices may be associated with one or more terminal device IDs, a source IP address, a destination IP address, a source port number, or a destination port number.

In an example, the control function entity may be a RIMC function entity.

In an example, the RAN device and the control function entity may be deployed in a ToB scenario.

The units 1310˜1320 can be implemented as a pure hardware solution or as a combination of software and hardware, e.g., by one or more of: a processor or a micro-processor and adequate software and memory for storing the software, a Programmable Logic Device (PLD) or other electronic component(s) or processing circuitry configured to perform the actions described above, and illustrated, e.g., in FIG. 7.

FIG. 14 is a block diagram of a RAN device 1400 according to another embodiment of the present disclosure.

The RAN device 1400 includes a communication interface 1410, a processor 1420 and a memory 1430. The memory 1430 contains instructions executable by the processor 1420 whereby the RAN device 1400 is operative to perform the actions, e.g., of the process described earlier in conjunction with FIG. 7.

As an example, the RAN device 1400 can be the RAN device 113 shown in FIG. 1. Particularly, the memory 1430 can contain instructions executable by the processor 1420 whereby the RAN device 1400 is operative to: receive, from a control function entity, a QoS profile or QoS parameter for a service for adjusting a QoS associated with the service for one or more terminal devices, or a scheduling configuration for a service for adjusting a QoS associated with the service for one or more terminal devices; and apply the QoS profile or QoS parameter or the scheduling configuration to the service for the one or more terminal devices.

In an example, the QoS profile or QoS parameter or the scheduling configuration may be associated with a time period, and the operation of applying the QoS profile or QoS parameter or the scheduling configuration may include applying the QoS profile or QoS parameter or the scheduling configuration for the time period.

In an example, the QoS profile or QoS parameter may be a default QoS profile or QoS parameter, or is dependent on a measurement or capability related to the RAN device.

In an example, the one or more terminal devices may be associated with one or more terminal device IDs, a source IP address, a destination IP address, a source port number, or a destination port number.

In an example, the control function entity may be a RIMC function entity.

In an example, the RAN device and the control function entity may be deployed in a ToB scenario.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1020, causes the application server 1000 to perform the actions, e.g., of the process described earlier in conjunction with FIG. 5, code/computer readable instructions, which when executed by the processor 1220, causes the control function entity 1200 to perform the actions, e.g., of the process described earlier in conjunction with FIG. 6, or code/computer readable instructions, which when executed by the processor 1420, causes the RAN device 1400 to perform the actions, e.g., of the process described earlier in conjunction with FIG. 7.

The computer program product may be configured as a computer program code structured in computer program modules. The computer program modules could essentially perform the actions of the flow illustrated in FIG. 5, 6, or 7.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-Access Memory (RAM), a Read-Only Memory (ROM), or an EEPROM, and the computer program modules described above could in alternative embodiments be distributed on different computer program products in the form of memories.

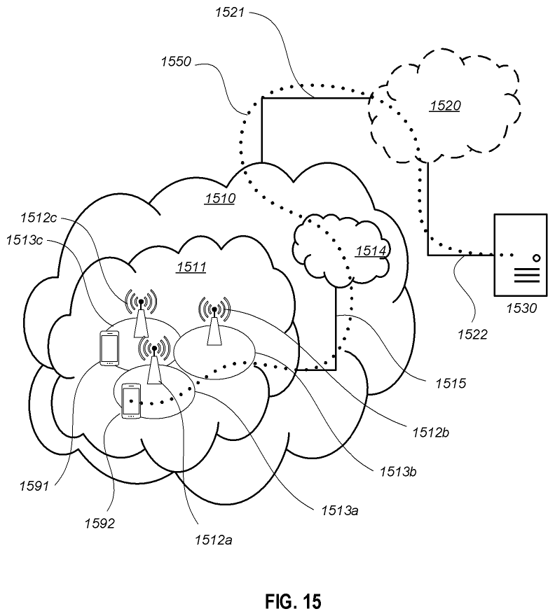

With reference to FIG. 15, in accordance with an embodiment, a communication system includes a telecommunication network 1510, such as a 3GPP-type cellular network, which comprises an access network 1511, such as a radio access network, and a core network 1514. The access network 1511 comprises a plurality of base stations 1512a, 1512b, 1512c, such as NBs, eNBs, gNBs or other types of wireless access points, each defining a corresponding coverage area 1512a, 1512b, 1512c. Each base station 1512a, 1512b, 1512c is connectable to the core network 1514 over a wired or wireless connection 1515. A first UE 1591 located in a coverage area 1512c is configured to wirelessly connect to, or be paged by, the corresponding base station 1512c. A second UE 1592 in a coverage area 1512a is wirelessly connectable to the corresponding base station 1512a. While a plurality of UEs 1591, 1592 are illustrated in this example, the disclosed embodiments are equally applicable to a situation where a sole UE is in the coverage area or where a sole UE is connecting to the corresponding base station 1512.

The telecommunication network 1510 is itself connected to a host computer 1530, which may be embodied in the hardware and/or software of a standalone server, a cloud-implemented server, a distributed server or as processing resources in a server farm. The host computer 1530 may be under the ownership or control of a service provider, or may be operated by the service provider or on behalf of the service provider. Connections 1521 and 1522 between the telecommunication network 1510 and the host computer 1530 may extend directly from the core network 1514 to the host computer 1530 or may go via an optional intermediate network 1520. An intermediate network 1520 may be one of, or a combination of more than one of, a public, private or hosted network; the intermediate network 1520, if any, may be a backbone network or the Internet; in particular, the intermediate network 1520 may comprise two or more sub-networks (not shown).

The communication system of FIG. 15 as a whole enables connectivity between the connected UEs 1591, 1592 and the host computer 1530. The connectivity may be described as an over-the-top (OTT) connection 1550. The host computer 1530 and the connected UEs 1591, 1592 are configured to communicate data and/or signaling via the OTT connection 1550, using the access network 1511, the core network 1514, any intermediate network 1520 and possible further infrastructure (not shown) as intermediaries. The OTT connection 1550 may be transparent in the sense that the participating communication devices through which the OTT connection 1550 passes are unaware of routing of uplink and downlink communications. For example, the base station 1512 may not or need not be informed about the past routing of an incoming downlink communication with data originating from the host computer 1530 to be forwarded (e.g., handed over) to a connected UE 1591. Similarly, the base station 1512 need not be aware of the future routing of an outgoing uplink communication originating from the UE 1591 towards the host computer 1530.

Example implementations, in accordance with an embodiment, of the UE, base station and host computer discussed in the preceding paragraphs will now be described with reference to FIG. 15. In a communication system 1500, a host computer 1510 comprises hardware 1515 including a communication interface 1516 configured to set up and maintain a wired or wireless connection with an interface of a different communication device of the communication system 1500. The host computer 1510 further comprises a processing circuitry 1518, which may have storage and/or processing capabilities. In particular, the processing circuitry 1518 may comprise one or more programmable processors, application-specific integrated circuits, field programmable gate arrays or combinations of these (not shown) adapted to execute instructions. The host computer 1510 further comprises software 1511, which is stored in or accessible by the host computer 1510 and executable by the processing circuitry 1518. The software 1511 includes a host application 1512. The host application 1512 may be operable to provide a service to a remote user, such as UE 1530 connecting via an OTT connection 1550 terminating at the UE 1530 and the host computer 1510. In providing the service to the remote user, the host application 1512 may provide user data which is transmitted using the OTT connection 1550.

The communication system 1500 further includes a base station 1520 provided in a telecommunication system and comprising hardware 1525 enabling it to communicate with the host computer 1510 and with the UE 1530. The hardware 1525 may include a communication interface 1526 for setting up and maintaining a wired or wireless connection with an interface of a different communication device of the communication system 1500, as well as a radio interface 1527 for setting up and maintaining at least a wireless connection 1570 with the UE 1530 located in a coverage area (not shown in FIG. 15) served by the base station 1520. The communication interface 1526 may be configured to facilitate a connection 1560 to the host computer 1510. The connection 1560 may be direct or it may pass through a core network (not shown in FIG. 15) of the telecommunication system and/or through one or more intermediate networks outside the telecommunication system. In the embodiment shown, the hardware 1525 of the base station 1520 further includes a processing circuitry 1528, which may comprise one or more programmable processors, application-specific integrated circuits, field programmable gate arrays or combinations of these (not shown) adapted to execute instructions. The base station 1520 further has software 1521 stored internally or accessible via an external connection.

The communication system 1500 further includes the UE 1530 already referred to. Its hardware 1535 may include a radio interface 1537 configured to set up and maintain a wireless connection 1570 with a base station serving a coverage area in which the UE 1530 is currently located. The hardware 1535 of the UE 1530 further includes a processing circuitry 1538, which may comprise one or more programmable processors, application-specific integrated circuits, field programmable gate arrays or combinations of these (not shown) adapted to execute instructions. The UE 1530 further comprises software 1531, which is stored in or accessible by the UE 1530 and executable by the processing circuitry 1538. The software 1531 includes a client application 1532. The client application 1532 may be operable to provide a service to a human or non-human user via the UE 1530, with the support of the host computer 1510. In the host computer 1510, an executing host application 1512 may communicate with the executing client application 1532 via the OTT connection 1550 terminating at the UE 1530 and the host computer 1510. In providing the service to the user, the client application 1532 may receive request data from the host application 1512 and provide user data in response to the request data. The OTT connection 1550 may transfer both the request data and the user data. The client application 1532 may interact with the user to generate the user data that it provides.

It is noted that the host computer 1510, the base station 1520 and the UE 1530 illustrated in FIG. 15 may be similar or identical to the host computer 1530, one of base stations 1512a, 1512b, 1512c and one of UEs 1591, 1592 of FIG. 15, respectively. This is to say, the inner workings of these entities may be as shown in FIG. 15 and independently, the surrounding network topology may be that of FIG. 15.

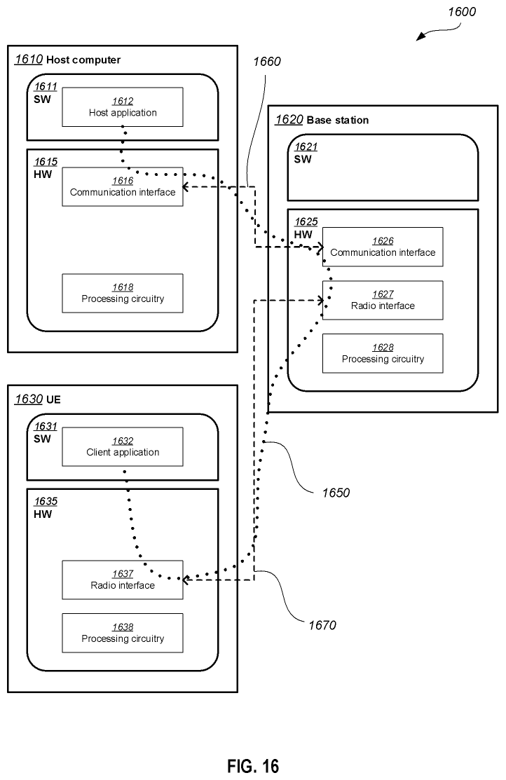

In FIG. 16, the OTT connection 1650 has been drawn abstractly to illustrate the communication between the host computer 1610 and the UE 1630 via the base station 1620, without explicit reference to any intermediary devices and the precise routing of messages via these devices. Network infrastructure may determine the routing, which it may be configured to hide from the UE 1630 or from the service provider operating the host computer 1610, or both. While the OTT connection 1650 is active, the network infrastructure may further take decisions by which it dynamically changes the routing (e.g., on the basis of load balancing consideration or reconfiguration of the network).

Wireless connection 1670 between the UE 1630 and the base station 1620 is in accordance with the teachings of the embodiments described throughout this disclosure. One or more of the various embodiments improve the performance of OTT services provided to the UE 1630 using the OTT connection 1650, in which the wireless connection 1670 forms the last segment. More precisely, the teachings of these embodiments may improve the data rate and latency, and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 1650 between the host computer 1610 and the UE 1630, in response to variations in the measurement results. The measurement procedure and/or the network functionality for reconfiguring the OTT connection 1650 may be implemented in software 1611 and hardware 1615 of the host computer 1610 or in software 1631 and hardware 1635 of the UE 1630, or both. In embodiments, sensors (not shown) may be deployed in or in association with communication devices through which the OTT connection 1650 passes; the sensors may participate in the measurement procedure by supplying values of the monitored quantities exemplified above, or supplying values of other physical quantities from which the software 1611, 1631 may compute or estimate the monitored quantities. The reconfiguring of the OTT connection 1650 may include message format, retransmission settings, preferred routing etc.; the reconfiguring need not affect the base station 1620, and it may be unknown or imperceptible to the base station 1620. Such procedures and functionalities may be known and practiced in the art. In certain embodiments, measurements may involve proprietary UE signaling facilitating the host computer 1610's measurements of throughput, propagation times, latency and the like. The measurements may be implemented in that the software 1611 and 1631 causes messages to be transmitted, in particular empty or ‘dummy’ messages, using the OTT connection 1650 while it monitors propagation times, errors etc.

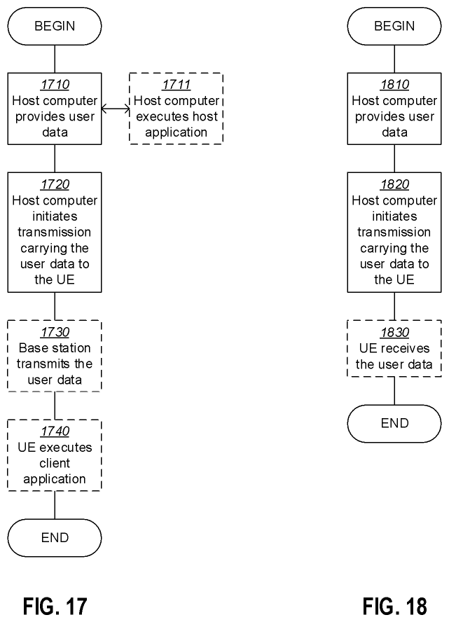

FIG. 17 is a flowchart illustrating a method implemented in a communication system, in accordance with an embodiment. The communication system includes a host computer, a base station and a UE which may be those described with reference to FIG. 15 and FIG. 16. For simplicity of the present disclosure, only drawing references to FIG. 17 will be included in this section. In step 1710, the host computer provides user data. In substep 1711 (which may be optional) of step 1710, the host computer provides the user data by executing a host application. In step 1720, the host computer initiates a transmission carrying the user data to the UE. In step 1730 (which may be optional), the base station transmits to the UE the user data which was carried in the transmission that the host computer initiated, in accordance with the teachings of the embodiments described throughout this disclosure. In step 1740 (which may also be optional), the UE executes a client application associated with the host application executed by the host computer.

FIG. 18 is a flowchart illustrating a method implemented in a communication system, in accordance with an embodiment. The communication system includes a host computer, a base station and a UE which may be those described with reference to FIG. 15 and FIG. 16. For simplicity of the present disclosure, only drawing references to FIG. 18 will be included in this section. In step 1810 of the method, the host computer provides user data. In an optional substep (not shown) the host computer provides the user data by executing a host application. In step 1820, the host computer initiates a transmission carrying the user data to the UE. The transmission may pass via the base station, in accordance with the teachings of the embodiments described throughout this disclosure. In step 1830 (which may be optional), the UE receives the user data carried in the transmission.

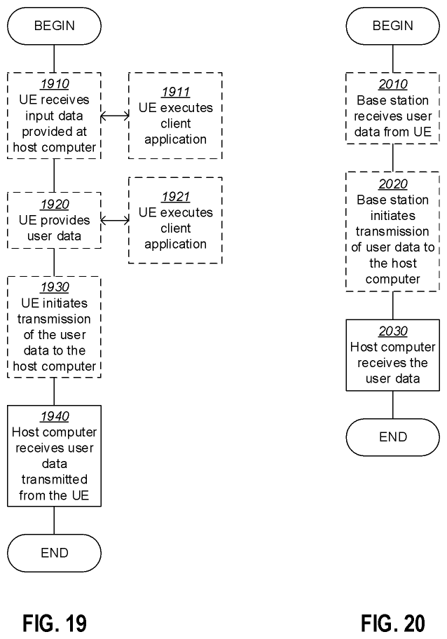

FIG. 19 is a flowchart illustrating a method implemented in a communication system, in accordance with an embodiment. The communication system includes a host computer, a base station and a UE which may be those described with reference to FIG. 15 and FIG. 16. For simplicity of the present disclosure, only drawing references to FIG. 19 will be included in this section. In step 1910 (which may be optional), the UE receives input data provided by the host computer. Additionally or alternatively, in step 1920, the UE provides user data. In substep 1921 (which may be optional) of step 1920, the UE provides the user data by executing a client application. In substep 1911 (which may be optional) of step 1910, the UE executes a client application which provides the user data in reaction to the received input data provided by the host computer. In providing the user data, the executed client application may further consider user input received from the user. Regardless of the specific manner in which the user data was provided, the UE initiates, in substep 1930 (which may be optional), transmission of the user data to the host computer. In step 1940 of the method, the host computer receives the user data transmitted from the UE, in accordance with the teachings of the embodiments described throughout this disclosure.

FIG. 20 is a flowchart illustrating a method implemented in a communication system, in accordance with an embodiment. The communication system includes a host computer, a base station and a UE which may be those described with reference to FIG. 15 and FIG. 16. For simplicity of the present disclosure, only drawing references to FIG. 20 will be included in this section. In step 2010 (which may be optional), in accordance with the teachings of the embodiments described throughout this disclosure, the base station receives user data from the UE. In step 2020 (which may be optional), the base station initiates transmission of the received user data to the host computer. In step 2030 (which may be optional), the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method, in an application server, for Quality of Service, QoS, control, comprising:
determining to adjust a QoS associated with a service for one or more terminal devices; and
transmitting, to a control function entity, a request for adjusting the QoS for the one or more terminal devices.

2. The method of claim 1, wherein said determining comprises determining to adjust the QoS for a time period, and the request is for adjusting the QoS for the time period.

3. The method of claim 1, wherein said determining is based on an estimated QoS for the service and a required QoS for the service.

4. The method of claim 3, wherein the estimated QoS is determined based on a QoS measured previously for the service by the application server.

5. The method of claim 3 or 4, wherein the request contains the required QoS, or a QoS profile or QoS parameter based on the required QoS.

6. The method of claim 1, wherein the QoS is based on a default QoS profile or QoS parameter and said determining is based on a required QoS for the service being higher than the QoS.

7. The method of claim 6, further comprising:
determining to adjust back to the QoS based on the default QoS profile or QoS parameter; and
transmitting, to the control function entity, a request for adjusting back to the QoS based on the default QoS profile or QoS parameter.

8. The method of claim 3, wherein said determining is further based on a measurement or capability related to a Radio Access Network, RAN, device from the control function entity.

9. The method of claim 1, wherein the one or more terminal devices are associated with one or more terminal device identifiers, IDs, a source Internet Protocol, IP, address, a destination IP address, a source port number, and/or a destination port number.

10. The method of claim 7, wherein the control function entity interfaces with the RAN device.

11. The method of claim 1, wherein the control function entity is a Radio Intelligent Management and Control, RIMC, function entity.

12. The method of claim 7, wherein the application server, the RAN device, and the control function entity are deployed in a To Business, ToB, scenario.

13.-14. (canceled)

15. A method, in a control function entity, for Quality of Service, QoS, control, comprising:
receiving, from an application server, a request for adjusting a QoS associated with a service for one or more terminal devices; and
transmitting, to a Radio Access Network, RAN, device, a QoS profile or QoS parameter associated with the service for the one or more terminal devices based on the request, or a scheduling configuration associated with the service for the one or more terminal devices based on the request.

16. The method of claim 15, wherein the request is for adjusting the QoS for a time period, and the QoS profile or QoS parameter or the scheduling configuration is associated with the time period.

17. The method of claim 15, wherein the request contains a required QoS for the service, and the method further comprises:
determining the QoS profile or QoS parameter or the scheduling configuration based on the required QoS.

18. The method of claim 17, wherein the QoS is based on a default QoS profile or QoS parameter and the request is received in response to the required QoS for the service being higher than the QoS.

19. The method of claim 17, wherein the QoS profile or Qos parameter or the scheduling configuration is determined further based on a measurement or capability related to the RAN device.

20. The method of claim 19, further comprising:
transmitting, to the application server, the measurement or capability related to the RAN device.

21. The method of claim 18, further comprising:
receiving, from the application server, a request for adjusting back to the QoS based on the default QoS profile or QoS parameter; and
transmitting, to the RAN device, the default QoS profile or QoS parameter.

22.-29. (canceled)

30. A method, in a Radio Access Network, RAN, device, for Quality of Service, QoS, control, comprising:
receiving, from a control function entity, a QoS profile or QoS parameter for a service for adjusting a QoS associated with the service for one or more terminal devices, or a scheduling configuration for a service for adjusting a QoS associated with the service for one or more terminal devices; and
applying the QoS profile or QoS parameter or the scheduling configuration to the service for the one or more terminal devices.

31.-37. (canceled)
